(19) United States
(12) Patent Application Publication
(10) Pub. No.: US 2012/0192431 A9
(43) Pub. Date: Aug. 2, 2012

(54) Blades for Shaving Razors

(76) Inventor: Kevin James Wain, Reading (GB)

(21) Appl. No.: 12/652,853

(22) Filed: Jan. 6, 2010

Related U.S. Application Data
(60) Provisional application No. 61/262,344, filed on Nov. 18, 2009.

(51) Int. Cl. B26B 21/14; B26B 21/00

(52) U.S. Cl. 30/50; 30/77; 30/84

(57) ABSTRACT

A shaving cartridge with a housing having a guard and a cap that define a shaving plane tangential thereto. The housing has a first blade with a blade edge positioned between the guard and the cap. A second blade has a blade edge positioned between the cap and the blade edge of the first blade. The first blade defines a plurality of rinse-through openings positioned between the blade edge of the first blade and the blade edge of the second blade.

### FIELD OF THE INVENTION

The present invention relates to shaving razors and cartridges and more particularly to shaving cartridges that have one or more blades with a plurality of rinse-through openings.

### BACKGROUND OF THE INVENTION

In general, shaving razors of the wet shave type include a cartridge or blade unit with at least one blade with a cutting edge which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The connection of the cartridge to the handle provides a pivotal mounting of the cartridge with respect to the handle so that the cartridge angle adjusts to follow the contours of the surface being shaved. In such systems, the cartridge can be biased toward a rest position by the action of a spring-biased plunger (a cam follower) carried on the handle against a cam surface on the cartridge housing. Razor cartridges usually include a guard which contacts the skin in front of the blade(s) and a cap for contacting the skin behind the blade(s) during shaving. The cap and guard aid in establishing the so-called “shaving geometry”, i.e., the parameters which determine the blade orientation and position relative to the skin during shaving, which in turn have a strong influence on the shaving performance and efficacy of the razor. The guard may be generally rigid, for example, formed integrally with a frame or platform structure which provides support for the blades.

In recent years shaving razors with numerous blades have been proposed in the literature and commercialized. In general, additional blades provide a closer shave, but increase the overall size of the shaving cartridge. Larger cartridges make it difficult to accurately contour facial hair or shave certain areas of the skin (e.g., around the mouth and chin) because the cartridge blocks from the view of the user the area being shaved or trimmed. In general, a smaller cartridge footprint is preferred by consumers to maneuver the cartridge around smaller areas of the face, such as around the nose and chin. Furthermore, some consumers prefer the look of a neatly contoured mustache or beard. The blades may be positioned closer together to decrease the size of the cartridge, but placing the blades edges closer together can negatively influence the rinsability of the blades.

The addition of more blades also significantly increases the cost of the cartridge. Shaving blades are expensive to manufacture and some designs require multiple components, for example, some cartridges include a blade mounted on a bent support member that is joined to a housing. The support members must be bent at significant angles (e.g., 60 degrees) to obtain a sufficient shaving angle relative to a shaving plane (i.e., a tangent line drawn from the guard to the cap of the cartridge). The bent metal support member provides the blade with sufficient support to withstand forces applied to blade during the shaving process. Other designs try to eliminate the blade support member by providing a bent blade; however, stringent material requirements for the blade edges may limit the amount blades can be bent consistently and accurately. Furthermore, the bending of blades limits how close together the blades may be positioned.

### SUMMARY OF THE INVENTION

In one aspect, the invention features, in general, a shaving cartridge having a housing with a guard and a cap that define a shaving plane tangential thereto. A first blade has a blade edge between the guard and the cap. A second blade has a blade edge between the cap and the blade edge of the first blade. The first blade defines a plurality of rinse-through openings positioned between the blade edge of the first blade and the blade edge of the second blade.

In another aspect, the invention features, in general, a shaving cartridge having a housing with a guard and a cap that define a shaving plane tangential thereto. A first blade has a blade edge between the guard and the cap. The first blade defines a plurality of rinse-through openings. A second blade directly contacts the first blade and has a blade edge. The second blade defines a plurality of rinse-through openings that overlap the plurality of rinse-through openings of the first blade. A third blade directly contacts the second blade and has a blade edge. The rinse-through openings of the first blade are positioned between the blade edges of the first and second blades and the rinse-through openings of the second blade are positioned between the edges of the second and third blades.

In another aspect, the invention features, in general a shaving cartridge with a housing having a guard and a cap that define a shaving plane tangential thereto. A first blade has a blade edge between the guard and the cap. The first blade defines a plurality of rinse-through openings. A second blade has a blade edge that overlaps the plurality of rinse-through openings of the first blade. The second blade defines a plurality of rinse-through openings that overlap the plurality of rinse-through openings of the first blade.

### BRIEF DESCRIPTION OF THE DRAWINGS

FIG. 1 is a bottom view of a shaving razor.

FIG. 2 is a perspective view of a plurality of blades which may be incorporated into the shaving razor of FIG. 1.

FIG. 3 is a cross section partial side view of a cartridge, taken generally on the line 3-3 of FIG. 1.

FIG. 4 is a top perspective view of a cartridge which may be incorporated into the shaving razor of FIG. 1.

FIG. 5A-5E are bottom views of the cartridge of FIG. 4 at various stages of an assembly process.

FIG. 6 is a top view of the shaving razor FIG. 1.

FIG. 7 is a cross section partial view of the shaving razor, taken generally along the line 7-7 of FIG. 6.

### DETAILED DESCRIPTION OF THE INVENTION

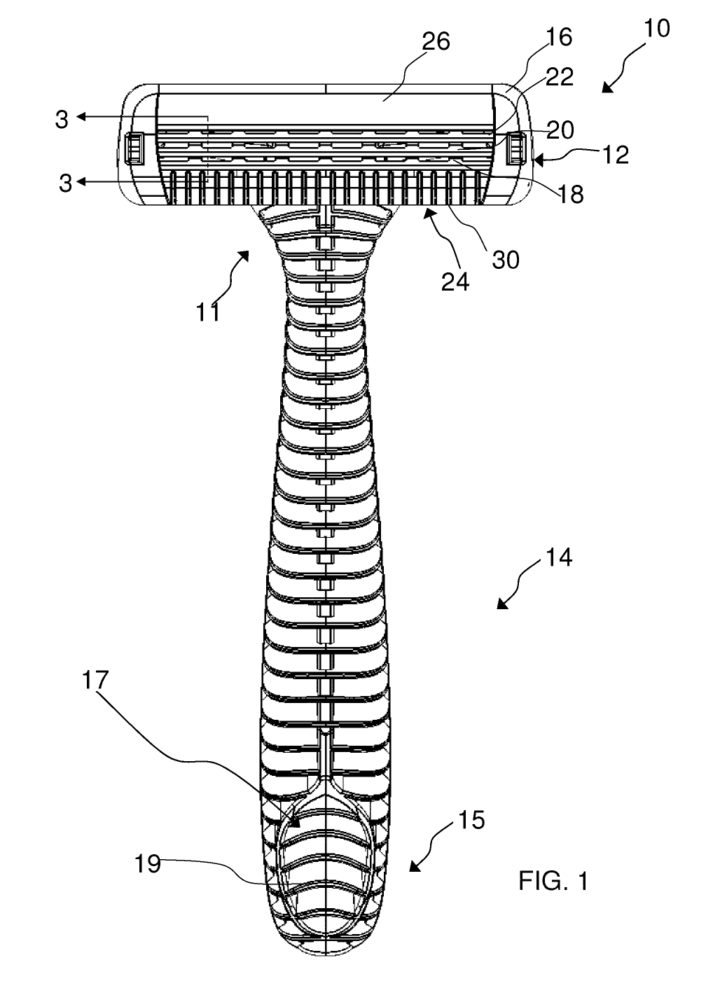

Referring to FIG. 1, one embodiment of the present invention is shown illustrating a shaving razor 10 having a shaving cartridge 12 mounted to a shaving razor handle 14. The shaving cartridge 12 may be pivotably (i.e., rotation of the cartridge 12 about an axis relative to the shaving razor handle 14) and/or detachably engaged to the shaving razor handle 14. The shaving cartridge 12 may include a housing 16 dimensioned to receive at least one blade (e.g., three blades 18, 20, and 22). Although three blades 18, 20 and 22 are shown, the housing 16 may have more or fewer blades depending on the desired performance and cost of the shaving razor 10.

The housing 16 may have a guard 24 in front of the blades 18, 20, and 22 and a cap 26 behind the blades 18, 20, and 22. As will be explained in greater detail below, the guard 24 and the cap 26 may aid in establishing a proper shaving geometry for the shaving cartridge 12. In certain embodiments, the first blade 18 may be the closest blade to the guard 24 and the third blade 22 may be the closest blade to the cap 26. The second blade 20 may be positioned between the first and the third blades 18 and 22. The blades 18, 20, and 22 may be mounted to the housing 16 and secured by staking, ultrasonic welding, insert molding, wire wrapping, or any other assembly/securing processes known to those skilled in the art. The guard 24 may have a plurality of spaced apart fingers 30 that extend transverse to the blades 18, 20, and 22. The spaced apart fingers 30 may facilitate the alignment of hair for efficient cutting by the blades 18, 20, and 22.

The handle 14 may have a proximal end portion 11 engaged to the housing 16 (e.g., pivotably and/or detachably joined) and a distal end portion 15. The distal end portion 15 may have recessed surface 17 on the same side as the guard 24, cap 26, and the blades 18, 20, and 22. The recessed surface 17 may be dimensioned to receive the fifth finger (pinky finger) of the user to allow for a more ergonomic grip of the handle 14. It is understood that the recessed surface 17 may provide an area for other fingers to grip depending on the desired orientation of the handle 14 in the user's hand. In certain embodiments, the recessed surface 17 may be an ellipse having a first radius perpendicular to the first blade 18 and a second radius parallel to the first blade 18. The first and second radii may be about 2 mm, 4 mm or 6 mm to about 8 mm, 10 mm, or 12 mm. The first radius may be larger than the second radius, for example, it is believed that an ellipse with a first radius of about 5 mm and a second radius of about 10 mm provides the user with a comfortable grip for the fifth finger. The area of the recessed surface 17 may be about 50 mm², 75 mm², or 100 mm² to about 200 mm², 300 mm², or 500 mm². It is understood that the recessed surface 17 may include other shapes, such as circles having a similar radius as those provided for the ellipse geometry. The recessed surface 17 may be smooth or may be textured to improve a user's grip. In certain embodiments, a plurality of ribs 19 may form the recessed surface 17. The ribs 19 may also improve the strength of the handle 14 and reduce material and manufacturing costs for injection molding.

The housing 16 and the handle 14 may be injection molded from a semi-rigid polymeric material. In certain embodiments, the housing 16 and/or the handle 14 may be molded from Noryl™ (a blend of polyphenylene oxide (PPO) and polystyrene developed by General Electric Plastics, now SABIC Innovative Plastics). The housing 16 and/or the handle 14 may be molded from other semi-rigid polymers having a Shore A hardness of about 60 to 140, including, but not limited to acrylonitrile butadiene styrene (ABS), acetal, polypropylene, high impact polystyrene, or any combinations thereof. The guard 24 may be molded from the same material as the housing 16 or a softer material. For example, the guard 24 may be molded from materials having a shore A hardness of about 20 to about 70, such as thermoplastic elastomers (TPEs) or rubbers. The cap 26 may also be molded from the same material as the housing 16. In certain embodiments, the cap 26 may have an elongated strip containing a shaving aid to provide lubrication to the surface of the skin during shaving.

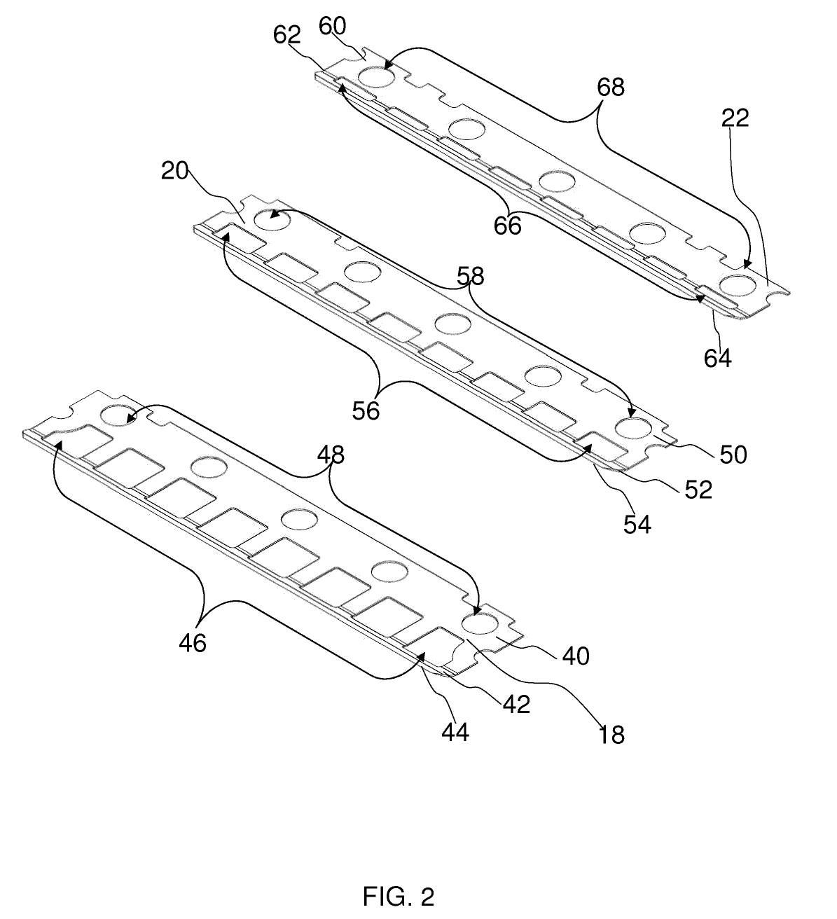

Referring to FIG. 2, perspective views of the first blade 18, the second blade 20, and the third blade 22 are shown. The first blade 18 may have a base portion 40 and a bent portion 42 with a blade edge 44. The first blade 18 may define a plurality of spaced apart mounting apertures 48 and a plurality of spaced apart rinse-through openings 46. The plurality of mounting apertures 48 may extend through the base portion 40 of the first blade 18. The plurality of spaced apart rinse-through openings 46 may extend through the base portion 40 and/or the bent portion 42 of the first blade 18. In certain embodiments, the rinse-through openings 46 may be rectangular and the plurality of mounting apertures 48 may be circular; however, a variety of other shapes may be used for the plurality of rinse-through openings 46 and the plurality of mounting apertures 48.

The second and third blades 20 and 22 may be similar to the first blade 18. The second and third blades 20 and 22 may each have respective base portions 50 and 60 and respective bent portions 52 and 62. The bent portions 52 and 62 of the second and third blades 20 and 22 may each have a respective blade edge 54 and 64. The blade edges 44, 54, and 64 may be configured to cut and/or pull the hair during a shaving stroke. The second and third blades 20 and 22 may each define a plurality of spaced apart mounting apertures 58 and 68 that extend through the respective base portions 50 and 60. The second and third blades 20 and 22 may each define a plurality of spaced apart rinse-through openings 56 and 66 that extend through the bent portions 52 and 62 and/or the base portions 50 and 60 of the respective second and third blades 20 and 22. As will be explained in greater detail below, the plurality of spaced apart rinse-through openings 46 of the first blade 18 may be dimensioned to overlap the plurality of spaced apart rinse-through openings 56 and 66 of the second and third blades 20 and 22 (i.e., after the blades 18, 20 and 22 are assembled to the housing 16). Accordingly, the rinse-through openings 46 of the first blade 18 may have a width that is greater than a width of the rinse-through openings 56 and 66 of the second and third blades 20 and 22. For example, the rinse-through openings 46 of the first blade 18 may have a width of about 2.5 mm, 2.75 mm, or 3 mm to about 3.5 mm, 4.0 mm, or 5 mm. The rinse-through openings 56 of the second blade 20 may have a width about 1.5 mm, 1.75 mm, or 1.90 mm to about 2.0 mm, 2.25 mm, or 2.49 mm. The rinse-through openings 66 of the third blade 22 may have a width about 0.70 mm, 0.80 mm, or 0.90 mm to about 1.0 mm, 1.25 mm, or 1.49 mm In certain embodiments, the rinse-through openings 46, 56, and 66 may have the same or similar length. For example, the rinse-through openings 46, 56, and 66 may each have a length of about 1.5 mm, 2.0 mm, or 2.5 mm to about 3 mm, 4 mm, or 5 mm.

The blades 18, 20, and 22 may be manufactured out of strips of stainless steel that are heat treated to improve strength. After heat treating the blade edges 44, 54, and 64 may be formed by commonly known sharpening methods. The blades 18, 20, and 22 may then have various types of lubricous coatings applied before or after the bending process. After sharpening, the blades 18, 20, and 22 may be placed in a fixture and bent to the desired angle prior to assembly with the housing 16. In certain embodiments, one or more of the blades 18, 20, and 22 may be cut such that each blade 18, 20, and 22 fits properly within the housing 16.

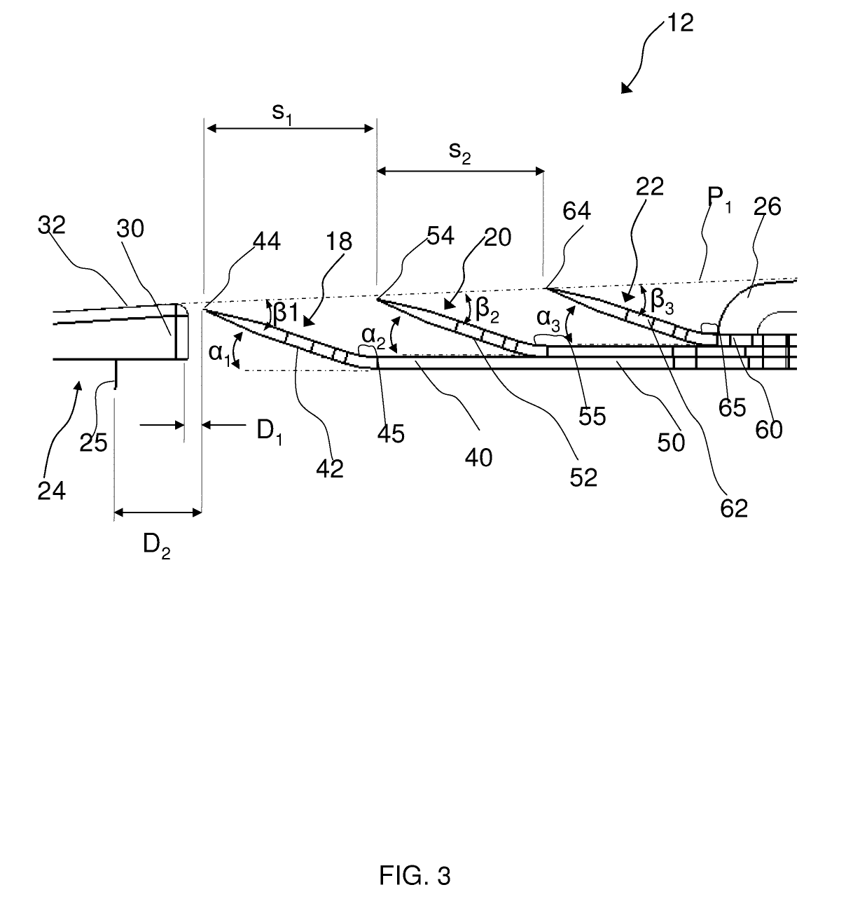

Referring to FIG. 3, a cross sectional side view of the cartridge 12, taken generally on the line 3-3 of FIG. 1 is shown. The shaving angle is one of the important factors that determines the comfort and closeness of a shave. The guard 24 (e.g., the more particularly the fingers 30) and the cap 26 may define a shaving plane P₁ tangential thereto. The blade edges 44, 54, and 64 may be positioned above (i.e., positive exposure), on (i.e., neutral exposure), or below (i.e., negative exposure) the shaving plane P₁. It is understood that the shaving plane P₁ is drawn tangent to a top surface 32 of the guard 24 (e.g., fingers 30), which may or may not include the fingers 30. The blade edges 44, 54, and 64 may each define a shaving angle β₁, β₂, and β₃ (respectively) relative to the shaving plane P₁ of about 16 degrees, 18 degrees, or 20 degrees to about 23 degrees, 27 degrees, or 30 degrees. The shaving angles β₁, β₂, and β₃ may be the same or may be different depending on the desired level of comfort and closeness. In certain embodiments, the shaving angles β₁, β₂, and β₃ for all three blades 18, 20, and 22 may be consistent to reduce manufacturing costs (e.g., the same blade may be used for all three blades).

The base portions 40, 50, and 60 may be generally parallel relative to the shaving plane P₁. For example, the base portions 40, 50, and 60 may be within about 0 degrees, 5 degrees, or 7 degrees to about 10 degrees, 17 degrees, or 25 degrees (e.g., converging or diverging) of being parallel to the shaving plane P₁. The generally parallel orientation of the base portions 40, 50, and 60 relative to the shaving plane P₁ may allow the blades 18, 20, and 22 to have a small singular bend that achieves the proper shaving angle β₁, β₂, and β₃. The generally parallel orientation of the base portions 40, 50, and 60 relative to the shaving plane P₁ may also allow for a more compact cartridge design. Typically, bent blades that are transverse (e.g., 90 degrees) to the shaving plane require either multiple bends or a larger bend angle to achieve the proper shaving angle. A larger bend angle and/or multiple bends may weaken the blade or increase costs and decrease consistency of the blade bending process. The bent portions 42, 52, and 62 of the first, second and third blades 18, 20, and 22 may each have a small singular bend 45, 55, and 65 oriented in an upward direction toward the shaving plane P₁ (e.g., bends 45, 55, and 65 face the shaving plane P₁). Typically, bent blades have base portions that are transverse to the shaving plane, which require the blades to be bent away from the shaving plane to achieve the proper shaving angle (i.e., the bends do not face the shaving plane).

The first, second and third blades 18, 20, and 22 may each have a bend angle “α₁”, “α₂”, and “α₃” that is defined by the respective bent portions 42, 52, and 62 and the respective base portions 40, 50, and 60. The bend angles α₁, α₂, and α₃ may be about 5 degrees, 10 degrees, or 15 degrees to about 17 degrees, 20 degrees, or 25 degrees. The shaving angles β₁, β₂, and β₃ are determined by adding the angle of the respective base portion 40, 50, and 60 relative to the shaving plane with the respective bend angle α₁, α₂, and α₃. In one particular embodiment, the base portions 40, 50, and 60 for each blade 18, 20, and 22 may be within about 3.8 degrees of being parallel to the shaving plane P₁ and each blade may have a respective bend angle α₁, α₂, and α₃ of about 18.7 degrees to achieve a desired shaving angle of about 22.5 degrees. It is understood that the bend angles α₁, α₂, and α₃ may be the same or different depending on the desired application. For example, in certain embodiments, having the same bend angle α₁, α₂, and α₃ may decrease manufacturing costs.

The blade edge 44 of the first blade 18 may be positioned above the guard 25 and below the shave plane P1 (i.e., a negative exposure). The finger 30 may be positioned above the blade edge 44 to minimize any skin bulge that may contact the blade edge 44 during shaving. The cartridge 12 may have a primary span D₁ and a secondary span D₂. The primary span D₁ may be the distance from the finger 30 to the blade edge 44 of the first blade 18 (i.e., the blade closest to the finger 30). In certain embodiments, the primary span D₁ may be about 0 mm, 0.75 mm, or 0.10 mm to about 0.15 mm, 0.25 mm, or 0.50 mm. The secondary span D₂ may be the distance from a front edge 25 of the guard 24 to the blade edge 44 of the first blade 18 (i.e., the blade closest to the guard 24). The primary span D₁ may be less than the secondary span D₂ (i.e., the fingers 30 may extend beyond the front edge 25 of the guard 24). For example, the secondary span D₂ may be about 0.5 mm, 0.60 mm, or 0.70 mm to about 0.75 mm, 1.0 mm, or 1.50 mm. The relatively small primary span D₁ may provide for increased safety and reduced nicks and cuts during shaving. In certain embodiments, the finger 30 may contact (i.e., a 0 mm primary span D₁) the blade edge 44 of the first blade 18 to provide maximum safety.

The cartridge 12 may have a first interblade span “S₁” and a second interblade span “S₂”. The first interblade span S₁ may be the distance between the blade edge 44 of the first blade 18 and the blade edge 54 of the second blade 20. The second interblade span S₂ may be the distance between the blade edge 54 of the second blade 20 and the blade edge 64 of the third blade 22. The blades 18, 20, and 22 may be directly mounted to each other (e.g., the second blade may be directly contacting the first and third blades 18 and 22) to decrease the first and/or second interblade spans S₁ and S₂. The generally parallel base portions 40, 50, and 60 and the bend angles α₁, α₂, and α₃ combined with the direct mounting of the blades 18, 20, and 22 may allow for minimal interblade spans. For example, the first and/or second interblade spans S₁ or S₂ may be about 0.20 mm, 0.25 mm, or 0.30 mm to about 0.35 mm, 0.45 mm, or 0.50 mm. It is understood that larger first and/or second interblade spans S₁ or S₂ are also possible. In other embodiments, the first and/or second interblade spans S₁ or S₂ may be about 0.50 mm, 0.75 mm, or 1.0 mm to about 1.25, 1.5 mm, or 1.75 mm. In certain embodiments, the bent portions 42, 52, and 62 may contact each other to provide the interblade spans S₁ or S₂ that are smaller. The base portions 40, 50, and 60 may provide an area for joining the blades 18, 20, and 22 together (e.g., adhesives or welding) such that the joining process does not interfere with the blade edges 44, 54, and 64.

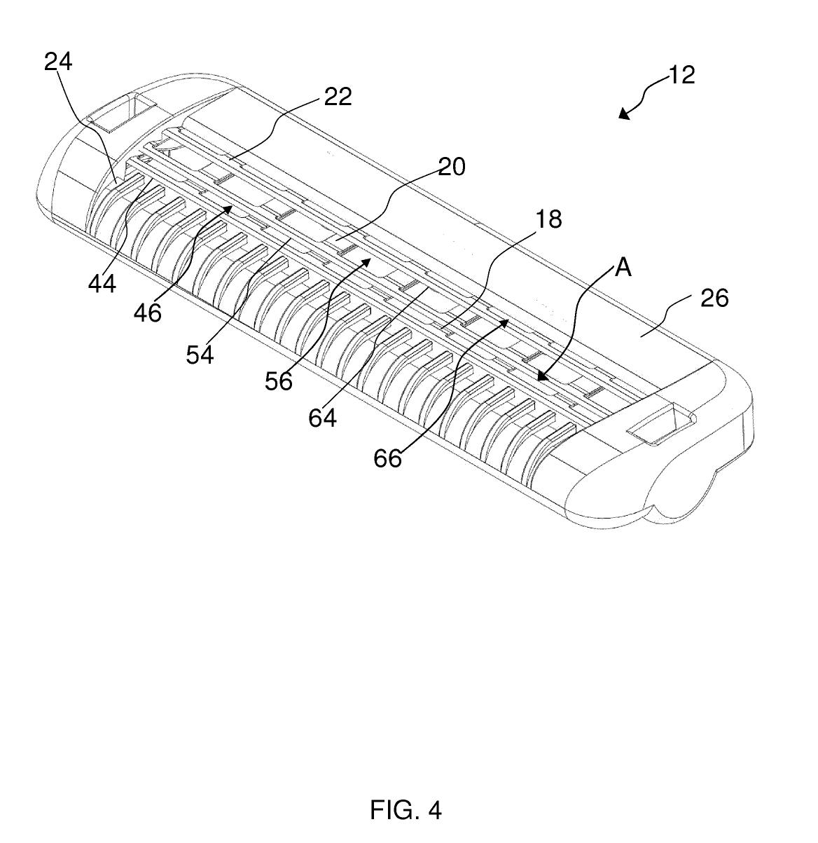

Referring to FIG. 4, a perspective view of the shaving cartridge 12 of FIG. 1 is shown. Shaving cartridges having smaller interblade spans are characteristically very difficult to rinse because shaving debris gets trapped between the blade edges. The design of the shaving cartridge 12 facilitates the close spacing of the blades 18, 20, and 22 (i.e., smaller interblade spans) combined with improved rinsability of the blades 18, 20, and 22 (especially the blade edges 44, 54, and 64). The blade edges 44, 54, and 64 may be positioned between the guard 24 and the cap 26. The plurality of rinse-through openings 46 defined by the first blade 18 may be positioned between the blade edges 44 and 54 of the first and second blades 18 and 20. For example, the blade edge 54 of the second blade 20 may overlap the plurality of rinse-through openings 46 defined by the first blade 18 to provide efficient rinsing of the blade edge 54. The plurality of rinse-through openings 56 defined by the second blade 20 may overlap the plurality of rinse-through openings 46 defined by the first blade 18 to facilitate the rinsing of the blade edge 64 of the third blade 22. The plurality of rinse-through openings 56 may be positioned between the blade edges 54 and 64 of the second and third blades 20 and 22. For example, the blade edge 64 of the third blade 22 may overlap the plurality of rinse-through openings 56 and 66. The plurality of rinse-through openings 66 defined by the third blade 22 may be positioned between the blade edge 64 of the third blade 20 and the cap 26. Alternatively, another blade (not shown) may be provided with a blade edge that overlaps plurality of rinse-through openings 66 defined by the third blade 22. The plurality of rinse-through openings 66 of the third blade 22 may overlap the plurality of rinse-through openings 46 and 56 of the first and second blades 18 and 20 to the facilitate removal of shaving debris from the third blade 22. The location of the rinse-through openings 46, 56, and 66 may allow more blades to be added to a cartridge and/or allow the blades to be spaced closer together without sacrificing the ability to sufficiently rinse the blades 18, 20, and 22 and the blade edges 44, 54, and 64.

In certain embodiments, the blades 18, 20, and 22 and the rinse-through openings 46, 56, and 66 may define a plurality of open areas for the passage of water and shaving debris that is less than the area of the individual rinse-through openings 46, 56, and 66 because the blades 18, 20 and 22 overlap the rinse-through openings 46, 56, and 66. For example, the first blade 18 may have a plurality of open areas “A” that are defined by the width and length of the rinse-through openings 46 and the second blade 20. The open areas “A” for each of the blades 18, 20 and 22 may be about 0.75 mm², 1.01 mm², 1.5 mm² to about 2.0 mm², 4.0 mm², or 6.0 mm². The open areas “A” for each of the blades 18, 20 and 22 may have a width of about 0.50 mm, 0.60 mm, or 0.70 mm to about 0.80 mm, 1.0 mm, or 1.2 mm and the same length as the respective individual rinse-through openings 46, 56, and 66.

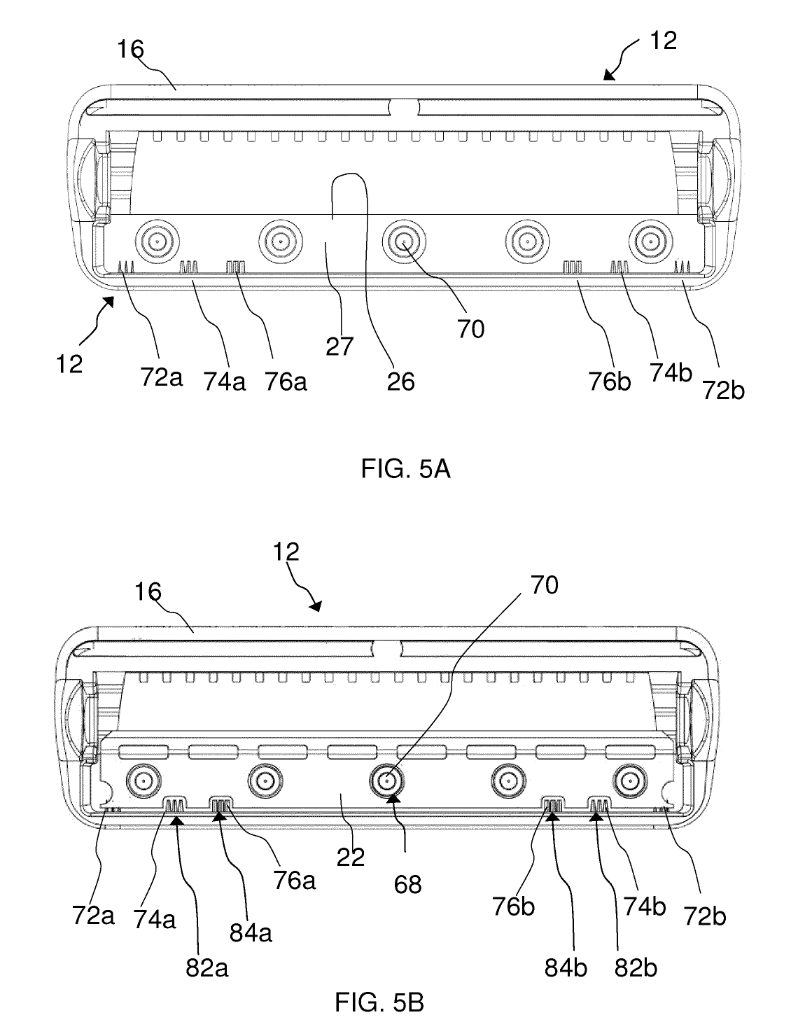

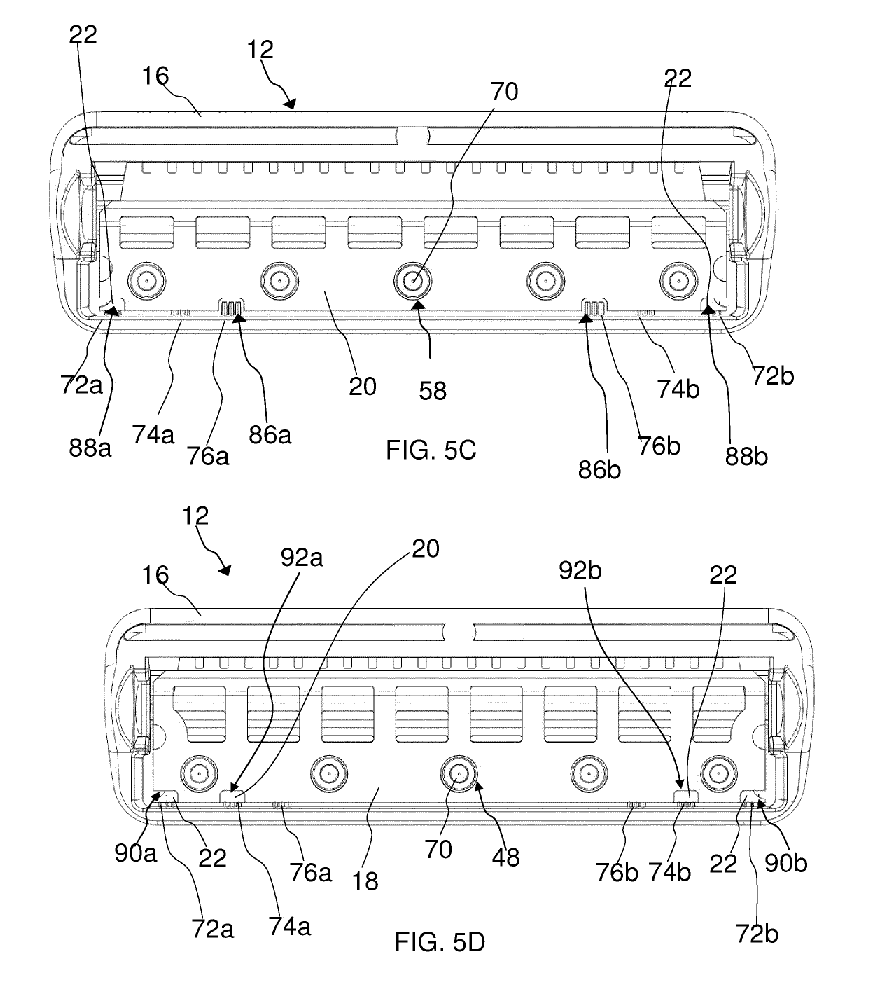

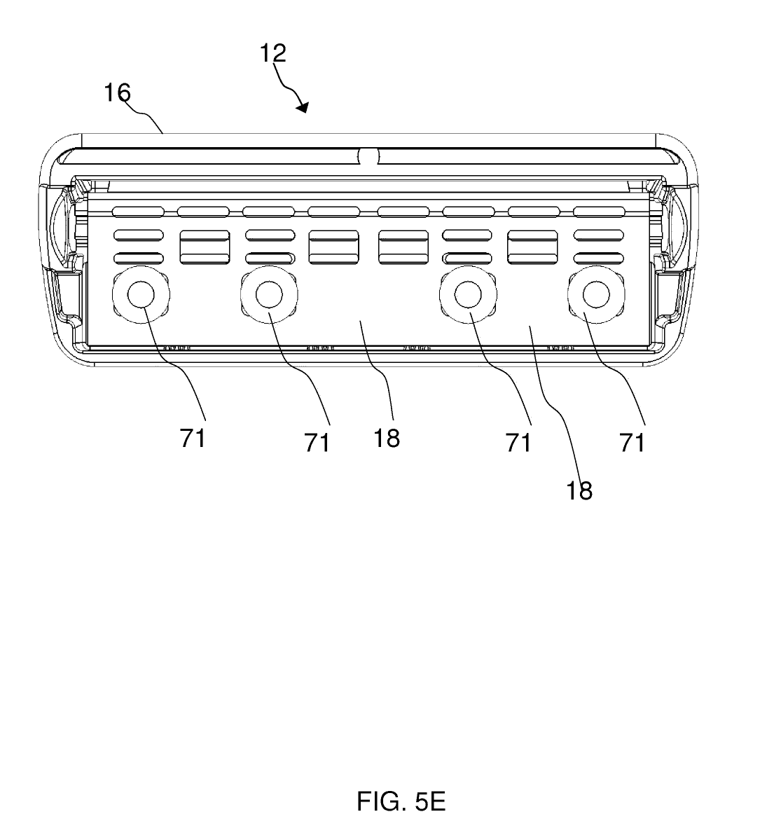

Referring to FIGS. 5A-5E, the cartridge 12 is shown at various stages of the assembly process. FIG. 5A illustrates a bottom view of the housing 16 prior to the assembly of the blades 18, 20, and 22. The housing 16 may have a plurality of bosses 70 that project from an underside 27 of the cap 26. The location of the bosses on the underside 27 of the cap 26 may provide for a more compact cartridge design. The bosses 70 may be dimensioned to fit within the mounting apertures 48, 58, and 68 of the blades 18, 20, and 22. The housing 16 may have a first pair of crush ribs 72a and 72b to facilitate the joining of the third blade 22 to the housing 16, as shown in FIG. 5B. The third blade 22 may be mounted to the housing 16 such that the bosses 70 are positioned within the mounting apertures 68 of the third blade 22. The third blade 22 may directly contact the first pair of crush ribs 72a and 72b to facilitate the joining of the third blade 22 to the housing 16.

The third blade 22 may have a first pair of slots 82a and 82b that are dimensioned to receive the second pair of crush ribs 74a and 74b such that the second pair of crush ribs 74a and 74b does not directly contact the third blade 22. The third blade 22 may also have a second pair of slots 84a and 84b dimensioned to receive the third pair of crush ribs 76a and 76b such that the third pair of crush ribs 76a and 76b does not directly contact the third blade 22. The first pair of slots 82a and 82b and the second pair of slots 84a and 84b of the third blade 22 may facilitate the joining of the first and second blades 18 and 20. For example, the first pair of slots 82a and 82b may allow the second blade to directly contact the second pair of crush ribs 74a and 74b. The second pair of slots 84a and 84b may allow the first blade to directly contact the third pair of crush ribs 76a and 76b.

Referring to FIG. 5C, the second blade 20 may be mounted to the housing 16 such that the bosses 70 are positioned within the mounting apertures 58 of the second blade 20. The second blade 20 may overlap and directly contact the second pair of crush ribs 74a and 74b. The second blade 20 may have a first pair of slots 86a and 86b that are dimensioned to overlap the second pair of slots 84a and 84b of the third blade, as well as, receive the third pair of crush ribs 76a and 76b such that the third pair of crush ribs 76a and 76b does not directly contact the second blade 20. The exposed third pair of crush ribs 76a and 76b may facilitate the joining of the first blade 18 to the housing 16. The second blade 20 may have a second pair of slots 88a and 88b that overlap the first pair of crush ribs 72a and 72b such that the first pair of crush ribs 72a and 72b does not contact directly the second blade 20.

Referring to FIG. 5D, the first blade 18 may be mounted to the housing 16 such that the bosses 70 are positioned within the mounting apertures 48 of the first blade 18. The first blade 18 may have a first pair of slots 90a and 90b that overlap the first pair of crush ribs 72a and 72b beneath the third blade 22. The first blade 18 may also have a second pair of slots 92a and 92b that overlap the second pair of crush ribs 74a and 74b beneath the second blade 20. The first blade 18 may overlap and directly contact the third pair of crush ribs 76a and 76b.

FIG. 5E shows a bottom view of the cartridge 12 after all of the blades 18, 20, and 22 have been joined to the housing 16. After the blades 18, 20 and 22 are assembled to the housing 16, the bosses 70 may be cold formed to form a plurality of clamp discs 71 on top of the first blade 18 to securely clamp the blades 18, 20, and 22 to the housing 16. Each blade 18, 20, and 22 may be securely joined between the clamp discs 71 and a pair of crush ribs (72a and 72b, 74a and 74b, or 76a and 76b). The slots 82a, 82b, 84a, 84b, 86a, 86b, 88a, 88b, 90a, 90b, 92a and 92b may minimize distortion of the blades 18, 20, and 22 during assembly and provide for a more secure joining of the blades 18, 20, and 22 to the housing 16 by ensuring that only one blade directly contacts only one of the pairs of crush ribs 72a, 72b, 74a, 74b, 76a, and 76b. Other joining processes such as heat staking, injection molding, and ultrasonic welding may also be used to join the blades 18, 20, and 22 to the housing 16. Alternative embodiments may include welding the first, second, and third blades 18, 20, and 22 together followed by cold forming, heat staking, injection molding, wire wrapping, or other assembly processes known to those skilled in the art to join the blades 18, 20, and 22 to each other and/or the housing 16.

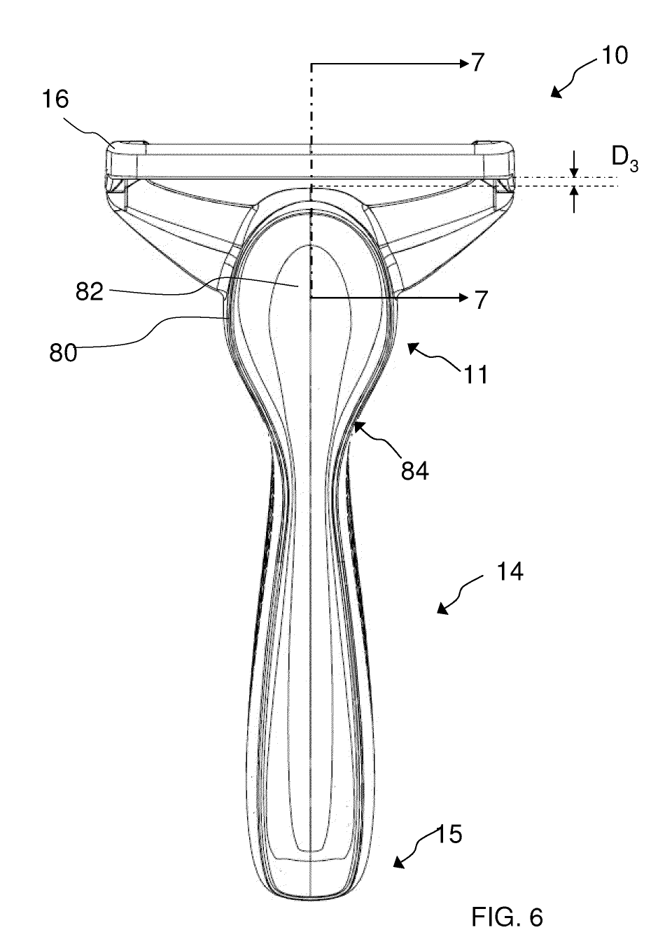

Referring to FIG. 6, a top view of the shaving razor 10 is shown. The handle 14 may have a rim 80 that defines a contoured recessed surface 82 opposite the guard 24, cap 26, and the blade edges 44, 54, and 64 (not shown). The contoured recessed surface 82 may be dimensioned to receive the index finger of the user to facilitate more precise manipulation of the housing 16 during shaving. In certain embodiments, the recessed surface 82 may be an ellipse having a first radius perpendicular to the first blade 18 and a second radius parallel to the first blade 18. The first and second radii may be about 4 mm, 6 mm, or 8 mm to about 12 mm, 14 mm, or 16 mm. The first radius may be larger than the second radius, for example, it is believed that an ellipse with a first radius of 12 mm and a second radius of 8 mm provides the consumer with a comfortable grip for the index finger and improves control of the shaving razor 10 during shaving. The area of the contoured recessed surface 82 may be greater than the area of the recessed surface 17 (see FIG. 1), for example, the contoured recessed surface 82 may be about 100 mm², 200 mm², or 300 mm² to about 400 mm², 600 mm², or 800 mm². It is understood that the contoured recessed surface 82 may include other shapes, such as circles having a similar radius as the radii provided for the ellipse geometry. The contoured recessed surface 82 may be smooth or may be textured to improve a grip.

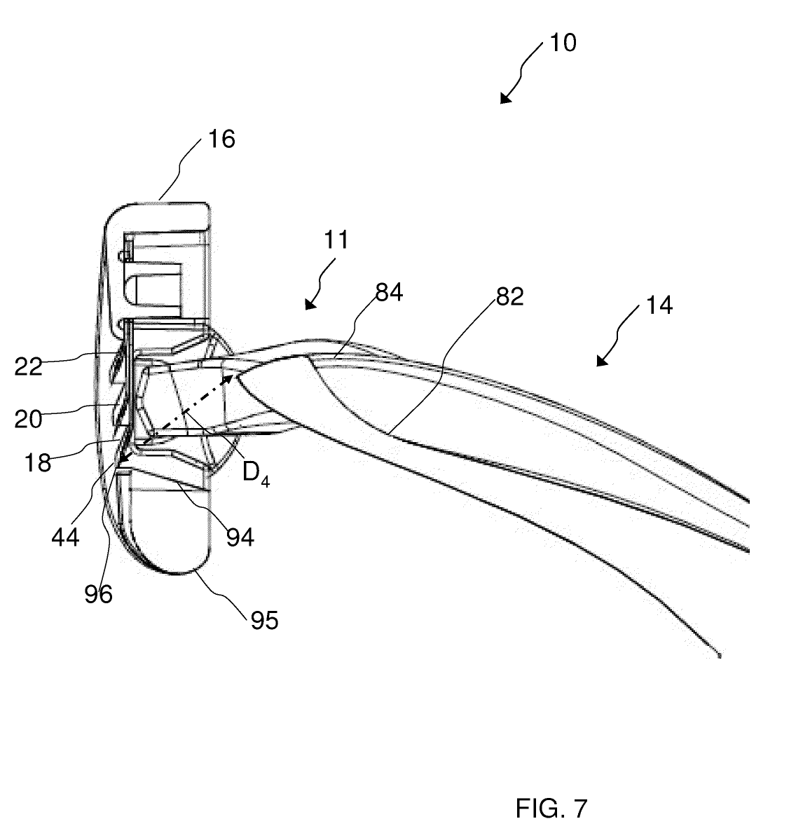

The rim 80 may be continuous, for example, the rim 80 may extend completely around an outer perimeter 84 of the handle 14 or the contoured recessed surface 82. In other embodiments, the rim 80 may be discontinuous, such as a crescent shape positioned at the proximal end portion 11 of the housing 16 in front of the contoured recessed surface 82. The rim 80 may prevent a user's finger from slipping off the handle 14 and contacting the housing 16 during shaving. The rim 80 may have a height of about 0.5 mm, 1.0 mm, or 1.5 mm to about 2.0 mm, 3.0 mm, or 5.0 mm relative to the contoured recessed area 82. The rim 80 and the contoured recessed area 82 may facilitate the user to position an index finger close to the housing 16. In certain embodiments, the housing 16 may be spaced apart from the rim 80 by a distance D₃ of about 2 mm, 3 mm, or 4 mm to about 6 mm, 7 mm, or 8 mm. If the housing 16 is spaced too close to the rim 80, the index finger of the user may interfere with the pivoting of the cartridge. It is understood that fixed (non-pivoting) shaving razors may have the rim 80 spaced closer or even touching the housing 16. The design of the housing 16 may also facilitate the placement of a user's finger closer to the first blade 18 for improved control of the shaving razor 10. For example, the blade edge 44 of the first blade 18 may be spaced apart from the rim 80 by a distance D₄ of about 5 mm, 7 mm, or 9 mm to about 12 mm, 14 mm, or 16 mm (as shown in FIG. 7).

Referring to FIG. 7, a cross section view of the shaving razor 10 is shown, taken generally along the line 7-7 of FIG. 6. In certain embodiments, the housing 16 may have an inner surface 94 of a side wall 95 with a recessed shoulder 96. The recessed shoulder 96 may directly contact the blade edge 44 to act as a stop to properly locate the blade edge 44 of the first blade 18. It is understood that the opposing side wall of the housing 16 is a mirror image and has a corresponding inner surface, side wall, and recessed shoulder to locate the other end of the blade edge 44. The inner surface 94 of the side wall 95 of the housing 16 may have a shoulder that contacts each blade edge to act as a stop. The recessed shoulder 96 may facilitate more accurate placement of the blades and minimize accumulated variation that is allowed by specified dimensions and tolerances. The recessed shoulder 96 may also eliminate the need of additional components to locate the blades 18, 20, and 22 within the housing 16.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge comprising:
a housing having a guard and a cap that define a shaving plane tangential thereto;
a first blade having a blade edge between the guard and the cap; and
a second blade having a blade edge positioned between the cap and the blade edge of the first blade, wherein the first blade defines a plurality of rinse-through openings positioned between the blade edge of the first blade and the blade edge of the second blade.

2. The shaving cartridge of claim 1 wherein the first blade directly contacts the second blade.

3. The shaving cartridge of claim 1 further comprising a third blade having a blade edge positioned between the blade edge of the second blade and the cap, wherein the second blade defines a plurality of rinse-through openings that overlap the plurality of rinse-through openings of the first blade and are positioned between the blade edges of the second and third blades.

4. The shaving cartridge of claim 3 wherein the second blade directly contacts the third blade.

5. The shaving cartridge of claim 3 wherein the third blade defines a plurality of rinse-through openings positioned between the blade edge of the third blade and the cap.

6. The shaving cartridge of claim 5 wherein the plurality of rinse-through openings of the third blade overlap the plurality of rinse-through openings of the first and second blades.

7. The shaving cartridge of claim 6 wherein the second blade is in direct contact with both the first and second blades.

8. The shaving cartridge of claim 1 wherein the guard has a plurality of fingers that extend transverse to the blades.

9. The shaving cartridge of claim 8 wherein the fingers and the blade edge of the first blade define a primary span of about 0 mm to about 0.50 mm.

10. The shaving cartridge of claim 9 wherein the a front edge of the guard and the blade edge of the first blade define a secondary span of about 0.50 mm to about 1.50 mm.

11. The shaving cartridge of claim 8 wherein the fingers extend beyond a front edge of the guard.

12. The shaving cartridge of claim 8 wherein the blade edges of the first and second blades define a first interblade span of about 0.25 mm to about 0.45 mm.

13. The shaving cartridge of claim 8 wherein the blade edges of the second and third blades define a second interblade span of about 0.25 mm to about 0.45 mm.

14. A shaving cartridge comprising:
a housing having a guard and a cap that define a shaving plane tangential thereto;
a first blade having a blade edge between the guard and the cap, the first blade defining a plurality of rinse-through openings;
a second blade directly contacting the first blade, the second blade having a blade edge and defining a plurality of rinse-through openings that overlap the plurality of rinse-through openings of the first blade; and
a third blade directly contacting the second blade and having a blade edge, wherein the rinse-through openings of the first blade are positioned between the blade edges of the first and second blades and the rinse-through openings of the second blade are positioned between the edges of the second and third blades.

15. The shaving cartridge of claim 14 wherein each of the blades has a base portion and a bent portion.

16. The shaving cartridge of claim 15 wherein the base portion of each of the blades is within 25 degrees of being parallel to the shaving plane.

17. The shaving cartridge of claim 16 wherein the bent portion of at least one of the blades has an angle relative to the respective base portion of about 5 degrees to about 25 degrees.

18. A shaving cartridge comprising:
a housing having a guard and a cap that define a shaving plane tangential thereto;
a first blade having a blade edge between the guard and the cap, the first blade defining a plurality of rinse-through openings;
a second blade having a blade edge that overlaps the plurality of rinse-through openings of the first blade, the second blade defining a plurality of rinse-through openings that overlap the plurality of rinse-through openings of the first blade.

19. The shaving cartridge of claim 18 further comprising a third blade having a blade edge that overlaps the plurality of rinse-through openings of the first and second blades.

20. The shaving cartridge of claim 19 wherein the second blade directly contacts the first and third blades.
